(19) United States
(12) Patent Application Publication
(10) Pub. No.: US 2008/0044522 A1
(43) Pub. Date: Feb. 21, 2008

(54) Nutrified coffee compositions

(76) Inventors: Jose Antonio, Deerfield Beach, FL (US); Anthony Michael Sanzari, Fort Lauderdale, FL (US); Scott David Pumper, Fort Lauderdale, FL (US)

Correspondence Address: Christopher J. Whewell;Western Patent Group, 6020 Tonkowa Trail, Georgetown, TX, 78628, US

(21) Appl. No.: 11/975,202

(22) Filed: Oct. 18, 2007

Related U.S. Application Data
(63) Continuation-in-part of application No. 10/933,672, filed on Sep. 3, 2004.

(51) Int. Cl. A23F 5/00; A23L 1/302; A23L 1/304

(52) U.S. Cl. 426/72; 426/74

(57) ABSTRACT

Provided herein are compositions of matter comprising a coffee, from which a coffee beverage may brewed. The compositions include one or more nutrient substances and thus afford a coffee beverage which contains beneficial health agents. Through consumption of a coffee beverage according to the invention, the health benefits of the added ingredients may be enjoyed by a consumer without need for modifying their general behavior in order to ingest such ingredients. The invention also provides methods for producing the compositions of the invention.

### CROSS-REFERENCES TO RELATED APPLICATIONS

This application is a Continuation-In-Part of U.S. patent application Ser. No. 10/933,672 filed Sep. 3, 2004, currently still pending, the entire contents of which are herein fully incorporated by reference.

### TECHNICAL FIELD

The present invention relates to compositions of matter from which beverages may be produced. More particularly, it relates to dry compositions from which liquid coffees may be produced through conventional brewing processes. The compositions of the invention provide coffees which contain various nutrient substances.

### BACKGROUND

According to the Specialty Coffee Association of America's 1999 market report, in 1999 there were 108,000,000 coffee consumers in the United States spending an approximated 9.2 billion dollars in the retail sector and 8.7 billion dollars in the foodservice sector every year. It can be inferred from this information that coffee drinkers spend on average $164.71 per year on coffee. The National Coffee Association found in 2000 that 54% of the adult population of the United States drinks coffee daily (NCA Coffee Drinking Trends Survey, 2000). They also reported that 18.12% of the coffee drinkers in the United States drink gourmet coffee beverages daily (NCA). In addition to the 54% who drink coffee everyday, 25% of Americans drink coffee occasionally (NCA).

The average consumption per capita in the United States is approximately 4.4 kg. Among coffee drinkers (i.e. not per capita) and the average consumption in the United States is 3.1 cups of coffee per day (NCA). Per capita, men drink approximately 1.9 cups per day, whereas women drink an average of 1.4 cups of coffee a day (NCA). Thus, it is clear that by utilizing a behavior that already exists in 100 million plus consumers, by adding greater nutritive value to coffee, the health and fitness of a large segment of the U.S. and perhaps world population can potentially be effected by controlling and beneficially enhancing the composition of the coffees consumed.

U.S. Pat. No. 5,571,441 discloses a vitamin supplement comprising: a) from about 3% to about 1000% of the RDA of vitamins; b) from about 10 mg to about 4000 mg flavanols; and c) a “bracer”, wherein the “bracer” delivers the bioequivalent alertness benefit of from about 10 mg to about 300 mg of caffeine.

U.S. Pat. No. 5,609,897 provides a powdered beverage concentrate consisting essentially of: a) calcium glycerophosphate; b) vitamin D; c) vegetable oil; d) a gum; e) vitamin C; f) an acidulant; g) a sweetener; h) a glucose polymer; and i) a flavoring agent, wherein the powdered beverage concentrate contains from 7.2 to 18.0% by wt. calcium.

U.S. Pat. No. 5,674,522 teaches a beverage concentrate comprising: a) a hot instant beverage selected from the group consisting of instant coffee and instant cocoa; and b) a therapeutically effective amount of pharmaceutical selected from the group consisting of antitussives, expectorants, antihistamines, sympathomimetics, laxatives, antidiarrheals, and mixtures thereof. Various compositions are claimed in the claims section, which indicate that pharmaceuticals in combination with coffee are known in the art.

U.S. Pat. No. 5,904,948 teaches a complete, nutritionally balanced coffee drink providing caloric and protein nutritional support for patients, particularly elderly and long-term care patients. An instant coffee composition, a method for making the instant coffee composition and coffee drink made therefrom are described, particularly at column 8, lines 16 to line 60 (example 4), which teaches coffee comprising a plurality of nutrients and vitamins. In another embodiment, the composition and drink has a caloric distribution including from about 16% to 30% of a protein component, from about 40% to 60% of a carbohydrate component and from about 15% to 33% of a lipid component. The instant coffee composition readily dissolves in hot water to provide a beverage which looks and tastes like black coffee which may be administered to a patient in need of nutritional support.

U.S. Pat. No. 6,036,984 describes a nutritional composition that when reconstituted with hot water provides a complete, nutritionally balanced, black coffee drink, the composition being in the form of an agglomerated, dissolvable powder comprising: a) coffee powder; b) from about 16% to about 30% of calories of a protein component exhibiting high clarity in aqueous solution for providing a black coffee drink; c) from about 40% to about 75% of calories of a carbohydrate component; and d) from about 15% to about 33% of calories of an atomized lipid component.

U.S. Pat. No. 6,207,203 provides a powder composition that provides a low-fat vitamin and mineral fortified coffee drink when reconstituted with water. The nutritional composition is in the form of a soluble powder containing an instant coffee component, a protein component, a vitamin/mineral component providing at least 25% of U.S. RDI per 8 oz serving, and a carbohydrate component in about 140 Cal per 8 oz serving.

U.S. Pat. No. 6,616,955 sets forth a beverage composition comprising: a) a calcium source comprising at least about 50 milligrams of the calcium source per reference serving of the composition and in a form selected from the group consisting of calcium carbonate, solubilized species thereof, and mixtures thereof; b) at least about 20 milligrams of a magnesium source per reference serving of the composition; c) at least about 0.5 milligrams of zinc per reference serving of the composition; d) from about 48 milligrams to about 170 milligrams of vitamin C per reference serving of the composition; e) a beverage component selected from the group consisting of water, fruit juice, tea solids, fruit flavors, botanical flavors, and mixtures thereof; and wherein the composition is substantially free of milk base solids and further comprising at least one nutrient selected from the group consisting of vitamin A, vitamin E, vitamin B6, vitamin B12, iron, and mixtures thereof.

### SUMMARY OF THE INVENTION

In one embodiment, the invention provides a method of delivering nutrients and dietary supplements to human subjects through their consumption of a liquid coffee beverage, by providing in the dried ground coffees from which such coffee beverages are prepared particular combinations of nutrients and/or dietary supplements, at particular concentrations. Once a coffee is brewed using a coffee composition of the invention, the nutrients appear in liquid form in the coffee, which becomes a functional coffee beverage. Thus, the present invention utilizes ground coffee (via brewing or steeping) as an ingredient in a method of delivering nutraceuticals or nutrients to the subject who consumes them. The present invention thus makes the consumption of nutrients and nutraceuticals easy and convenient, requiring no new behaviors or behavior modifications from consumers.

One embodiment of the invention provides a dry composition of matter which comprises: a) a ground coffee; b) added caffeine; and c) one or more materials selected from the group consisting of: citrus aurantium; garcinia cambogia; chromium; cayenne pepper; a source of calcium ions; green tea extract; an niacin.

Another embodiment provides a dry composition of matter which comprises: a) a ground coffee; b) deer velvet antler, present in an amount between about 2% and 6% by weight based on the total weight of the composition; and c) glutamine, present in any amount between about 0.25% and 0.75% by weight based on the total weight of the composition.

Another embodiment provides a dry composition of matter which comprises: a) a ground coffee; b) folic acid present in any amount between about 0.0005% and about 4% by weight based on the total weight of the composition; and c) one or more materials selected from the group consisting of: vitamin B6 present in any amount between about 0.004% and about 0.4% by weight based on the total weight of the composition; and vitamin B12 present in any amount between about 0.00001% and about 0.0002% by weight based on the total weight of the composition. Another embodiment includes provision of a further ingredient to the aforesaid composition, which is: d) one or more materials selected from the group consisting of: vitamin E; vitamin C; thiamin; riboflavin; niacin; biotin; and pantothenic acid.

A further embodiment of the invention provides a dry composition of matter which comprises: a) a ground coffee; b) 6% extract of citrus aurantium; c) 50% extract of garcinia cambogia; and d) chromium polynicotinate.

A further embodiment of the invention provides a dry composition of matter which comprises: a) a ground coffee; b) vitamin C; and c) grape seed extract.

A further embodiment of the invention provides a dry composition of matter which comprises: a) a ground coffee; b) ginkgo biloba extract; c) cytidine diphosphate choline; and d) vinpocetine.

A further embodiment of the invention provides a dry composition of matter which comprises: a) a ground coffee; b) garcinia cambogia extract (containing hydroxycitric acid, potassium, and calcium).

A further embodiment of the invention provides a dry composition of matter which comprises: a) a ground coffee; and b) micronized calcium citrate.

A further embodiment of the invention provides a dry composition of matter which comprises: a) a ground coffee; and b) coral calcium.

### BRIEF DESCRIPTION OF THE DRAWINGS

In the annexed drawings:

FIG. 1 shows the % fat of subjects who participated in a comparative study of the effects of a composition according to one embodiment of the invention versus straight coffee;

FIG. 2 shows the fat mass of subjects who participated in a comparative study of the effects of a composition according to one embodiment of the invention versus straight coffee;

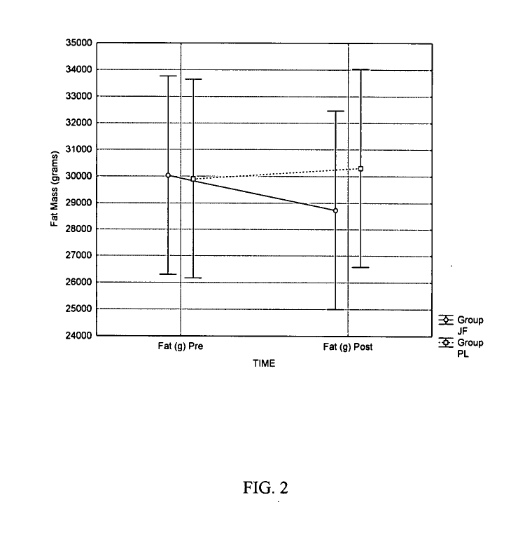

FIG. 3 shows the change in waist girth of subjects who participated in a comparative study of the effects of a composition according to one embodiment of the invention versus straight coffee;

FIG. 4 shows the change in hip girth of subjects who participated in a comparative study of the effects of a composition according to one embodiment of the invention versus straight coffee; and

FIG. 5 shows the change in body weight of subjects who participated in a comparative study of the effects of a composition according to one embodiment of the invention versus straight coffee.

### DETAILED DESCRIPTION

The present invention takes advantage of the extensive health benefits which coffee is known to possess an augments these advantages. As far back as 1977, it was demonstrated that there was no correlation between coffee consumption and certain risk factors as hypertension, heart infarction, diabetes, gout or cancer diseases, and no evidence has been proffered that coffee or its caffeine content are able to induce genetic alterations or even malformations (Czok, G. Coffee and Health Z. Ernahrungswiss, December 1977; 16 (4): 248-255). More recent data has shown that coffee, by itself, may have functional properties that confer benefits beyond thermogenesis and the oxidation of fat. (Acheson K J, Zahorska-Markiewicz B, Pittet P, Anantharaman K, Jequier E. Caffeine and coffee: their influence on metabolic rate and substrate utilization in normal weight and obese individuals. Am J Clin Nutr. May 1980;33(5):989-997; Zahorska-Markiewicz B. [Does post-caffeine increase in thermogenesis facilitate the treatment of obesity?]. Pol Tyg Lek. May 12, 1980;35(19):697-699; and Zahorska-Markiewicz B. The thermic effect of caffeinated and decaffeinated coffee ingested with breakfast. Acta Physiol Pol. January-February 1980;31(1):17-20). In a Nurses' Health Study and Health Professionals° Follow-up Study, scientists followed 41934 men from 1986 to 1998 and 84,276 women from 1980 to 1998. These participants did not have diabetes, cancer, or cardiovascular disease at baseline, and total caffeine intake from coffee and other sources was shown to reduce the risk for diabetes in both men and women. According to the study authors, “these data suggest that long-term coffee consumption is associated with a statistically significantly lower risk for type 2 diabetes.” (Salazar-Martinez E, Willett W C, Ascherio A, et al. Coffee consumption and risk for type 2 diabetes mellitus. Ann Intern Med. Jan. 6, 2004;140(1):1-8). Another observation is that coffee may decrease the risk of symptomatic gallstones in women. Also, coffee drinking does not increase the risk of CHD or death. (Ruhl C E, Everhart J E. Association of coffee consumption with gallbladder disease. Am J Epidemiol. Dec. 1, 2000;152(11):1034-1038). Furthermore, habitual coffee drinkers had lower blood pressure than non-drinkers at any levels of alcohol use, cigarette smoking, obesity, and glucose intolerance. (Kleemola P, Jousilahti P, Pietinen P, Vartiainen E, Tuomilehto J. Coffee consumption and the risk of coronary heart disease and death. Arch Intern Med. Dec. 11-25, 2000;160(22):3393-3400). Thus, it is evident that coffee has benefits beyond serving as a stimulant (via its caffeine effect (Fisone G, Borgkvist A, Usiello A. Caffeine as a psychomotor stimulant: mechanism of action. Cell Mol Life Sci. April 2004;61(7-8):857-872).

Our invention provides for the addition of nutrients or dietary supplements to dry coffees, which results in concentrations of 0.1-20% by weight based on the total weight of the dry ground coffee composition of each of the added ingredients. According to one embodiment, combinations comprising any two or more of the following ingredients are combined with ground coffee at individual concentrations of any value in the range of between about 0.0001% and about 20% by weight based on the total weight of the final dry composition produced (which contains ground coffee in a predominant amount), either singularly or in combination: caffeine; citrus aurantium; garcinia cambogia; calcium, potassium, chromium (preferably polynicotinate); cayenne pepper; deer velvet antler; glutamine; biotin; pantothenic acid; grape seed extract; ginkgo biloba extract; cytidine diphosphate choline complex; vinpocetine; green tea extract; calcium; vitamin E; vitamin C; thiamin; riboflavin; niacin; vitamin B6; folic Acid; and vitamin B12.

In order to provide a composition according to the present invention, dry ground coffee is first provided. To the coffee is next added appropriate amounts of the specified ingredients to yield the compositions of the invention, which are defined in terms of weight percent. According to one embodiment, the added ingredients are added to the ground coffee in their dry form and are tumbled, mechanically blended, or otherwise cocomminutated with ground coffee until they are uniformly distributed therethrough, after which the dry composition is packaged in any desired quantity. Preferably, the packaging is done under vacuum using techniques known to those skilled in the art in order to preserve the flavor.

In another form of the invention, a solution is made up containing appropriate amounts of the ingredients which are selected to be blended with a correspondingly appropriate quantity of the dry ground coffee. The solution is sprayed on the coffee grounds and the solvent is subsequently removed by evaporation. According to this method, the preferred solution is aqueous; however, other solvents than water which are capable of dissolving or suspending the ingredients to be added to the dry coffee grounds prior to their being applied to the coffee are suitable, including without limitation, organic solvents. It is preferred to exclude gaseous oxygen from the blending process of the dry coffee grounds with the one or more ingredients specified to be added thereto herein. Alternate embodiments of the present invention include the substitution of whole coffee beans in the place of ground coffee beans in the various process of the invention used to produce dry coffee compositions.

The present invention is applicable to a wide range of coffees. In fact, it is applicable to all varieties of coffees, regardless of the location at which they are grown, harvested, or produced, including without limitation the Liberica, Robusta, and Arabica coffee species.

The various ingredients useful in accordance with the invention include: caffeine; citrus aurantium; garcinia cambogia; chromium (preferably polynicotinate); calcium; potassium; cayenne pepper; deer velvet antler; glutamine; biotin; pantothenic acid; grape seed extract; ginkgo biloba extract; cytidine diphosphate choline complex; vinpocetine; green tea extract; calcium; vitamin E; vitamin C; thiamin; riboflavin; niacin; vitamin B6; folic Acid; and vitamin B12.

The substances vitamin E, vitamin C, thiamin, riboflavin, niacin, vinpocetine, calcium, potassium, vitamin B6, folic acid, glutamine, biotin, cytidine diphosphate choline ester, pantothenic acid, caffeine, chromium salts (including polynicotinate) and vitamin B12 are well known in the art materials of commerce, and are readily available from a wide range of commercial sources in their purified forms.

Citrus aurantium is known as the sour orange tree, and is sometimes referred to as bitter, bigarade, or Seville orange. In Spanish-speaking areas it may be called naranja acida, naranja agria, or naranja amarga. In Arabia, it is naranji, in Italy, melangolo, and in India, khatta. Extracts of this citrus aurantium are commercially available, and the extract used in the present invention is preferably that which exists in the form of a brown powder containing 6% by weight of synephrine. The preferred material used in the present invention is from NUTRITION FORMULATORS, of 11005 NW 33^{rd} Street of Miami Fla. 33172 and many other suppliers.

Garcinia cambogia is a yellowish pumpkin shaped tropical tree fruit native to India, and which contains hydroxy citric acid as a constituent. Several extract products are commercially, which contain typically 50% by weight of hydroxycitric acid. The 50% extract is preferred for use as an ingredient in the present invention. The preferred material used in the present invention is from NUTRITION FORMULATORS, of 11005 NW 33^{rd} Street of Miami Fla. 33172 and many other suppliers.

Cayenne pepper is a well known material which has been cultivated for centuries and is commercially available in ground powder form, which powders having an average particle size of less than about 0.2 mm are suitable for use in the present invention.

Deer velvet antler is a well known material of commerce which is harvested from deer species and is commercially available in a powder form from several well-known sources, which powders having an average particle size of less than about 0.2 mm are suitable for the present invention. The preferred material used in the present invention is from NUTRITION FORMULATORS, of 11005 NW 33^{rd} Street of Miami Fla. 33172 and many other suppliers.

Grape seed extracts are commercially available and are the extract of vitis vinifera and contain a variety of polyphenols and procyanidins. These materials are usually specified to contain a prescribed amount of oligomeric proanthocyanidins, typically at least about 85% by weight. The preferred grape seed extract material used in the present invention is from NUTRITION FORMULATORS, of 11005 NW 33^{rd} Street of Miami Fla. 33172 and many other suppliers.

Ginkgo biloba extract is the extract of the leaves of the common ginkgo biloba tree, and one common standardized ginkgo biloba extract utilizes a 50:1 ratio of leaves to extract. The preferred material used in the present invention is from NUTRITION FORMULATORS, of 11005 NW 33^{rd} Street of Miami Fla. 33172 and many other suppliers.

Green tea extract is an extract of the non-oxidized leaves of the camellia sinensis tree, of which there are many commercially-available sources. It is preferred that the green tea extract used in the present invention is standardized to contain at least about 60% by weight of epigallocatechin gallate (“EGCG”). The preferred material used in the present invention is from NUTRITION FORMULATORS, of 11005 NW 33^{rd} Street of Miami Fla. 33172 and many other suppliers.

The examples which follow are exemplary of the present invention, and shall not be construed as being delimitive thereof in any way.

### EXAMPLE 1

| Ingredient | Quantity | |
|---|---|---|
| ground coffee | 5.0 | grams |
| caffeine | 150 | milligrams |
| citrus aurantium (6% synephrine) | 120 | milligrams |
| garcinia cambogia extract (50% hydroxy | 400 | milligrams |
| citric acid by wt.) | | |
| chromium (polynicotinate) | 75 | micrograms |

### EXAMPLE 2

| Ingredient | Quantity | |
|---|---|---|
| ground coffee | 5.0 | grams |
| cayenne pepper (40,000 HU) | 150 | milligrams |
| caffeine | 150 | milligrams |
| Calcium, as dibasic calcium phosphate | 60 | milligrams |
| Green tea extract (standardized to | 160 | milligrams |
| 60% EGCG) | | |
| Niacin (niacinamide) | 20 | milligrams |

### EXAMPLE 3

| Ingredient | Quantity | |
|---|---|---|
| ground coffee | 5.0 | grams |
| Caffeine | 150 | milligrams |
| Garcinia cambogia (60% HCA) | 1 | milligram |
| Green tea extract (50% polyphenols, 37.5% | 160 | milligrams |
| catechins) | | |
| Niacin | 20 | milligrams |

### EXAMPLE 4

| Ingredient | Quantity | |
|---|---|---|
| ground coffee | 5.0 | grams |
| Calcium (chelated) | 200 | milligrams |

### EXAMPLE 5

| Ingredient | Quantity | |
|---|---|---|
| ground coffee | 5.0 | grams |
| Deer velvet antler | 200 | milligrams |
| Glutamine | 25 | milligrams |

### EXAMPLE 6

| Ingredient | Quantity | |
|---|---|---|
| ground coffee | 5.0 | grams |
| Folic acid | 0.2 | milligrams |
| Vitamin B6 (pyridoxine HCl) | 10 | milligrams |
| Vitamin B12 (cyanocobalamine) | 0.01 | milligrams |

### EXAMPLE 7

| Ingredient | Quantity | |
|---|---|---|
| ground coffee | 5.0 | grams |
| Vitamin E | 3 | international units |
| Vitamin C | 6 | milligrams |
| Thiamin | 0.15 | milligrams |
| Riboflavin | 0.17 | milligrams |
| Niacin | 2 | milligrams |
| Vitamin B6 | 0.2 | milligrams |
| Folic acid | 40 | micrograms |
| Vitamin B12 | 0.6 | micrograms |
| Biotin | 30 | micrograms |
| Pantothenic acid | 0.1 | milligrams |

### EXAMPLE 8

| Ingredient | Quantity | |
|---|---|---|
| ground coffee | 5.0 | grams |
| Citrus aurantium (6% synephrine) | 120 | milligrams |
| Garcinia cambogia extract (50% | 400 | milligrams |
| hydroxy citric acid) | | |
| Chromium polynicotinate | 75 | micrograms |

### EXAMPLE 9

| Ingredient | Quantity | |
|---|---|---|
| ground coffee | 5.0 | grams |
| Vitamin C | 60 | milligrams |
| Grape seed extract (85 + % OPC's) | 120 | milligrams |

### EXAMPLE 10

| Ingredient | Quantity | |
|---|---|---|
| ground coffee | 5.0 | grams |
| Ginkgo biloba extract | 50 | milligrams |
| Cytidine diphosphate choline | 10 | milligrams |
| vinpocetine | 5 | milligrams |

### EXAMPLE 11

| Ingredient | Quantity | |
|---|---|---|
| ground coffee | 5.0 | grams |
| garcinia cambogia extract (50% hydroxy citric acid) | 750 | milligrams |

### EXAMPLE 12

| Ingredient | Quantity | |
|---|---|---|
| ground coffee | 5.0 | grams |
| Calcium | 400 | milligrams |

In order to provide a coffee beverage for consumption, a dry ground coffee product made in accordance with any of the foregoing examples may be steeped or brewed using conventional coffee-preparation equipment, including drip-coffee makers, latte machines, “expresso” machines, and any other equipment known in the art to be useful in producing brewed beverages from ground beans or the like.

### Proven Beneficial Effects

Beneficial effects of a composition according to one embodiment of the invention were determined. In the study, for eight-weeks, 46 overweight, recreationally active men and women (mean±SD age, weight, % fat, respectively: 37.8±6.94 y, 80.7±15.9 kg; 38.6±8.4%) ingested one dose (2.0 tablespoons dissolved in 12 oz water) per day of JavaFit Diet Plus™ (the composition specified herein as Example 1) or regular caffeinated coffee 20-30 minutes prior to a standardized workout consisting of whole-body resistance exercise (˜30 min) followed by cardiovascular training (minimum of 3 sessions per week for a minimum of 15 minutes). Diet was unchanged but monitored via 3-day food diaries. Body composition was assessed pre and post via DEXA. Data were expressed as change from pre (week 0) values. Two-way ANOVA revealed a significant group x time decrease in % fat (JavaFit Diet Plus™ coffee: −1.1±1.1%; vs. regular coffee: +0.3±1.2%; p<0.001) and fat mass (JavaFit Diet Plus™ coffee: −1.3±1.4 kg; vs. regular coffee: +0.4±1.2 kg; p<0.001) over the course of the study. Significant decreases in waist girth (−0.56±0.34 cm; p<0.006), hip girth (−0.53±0.27 cm; p<0.001) and body weight (−1.54±1.7 kg; p<0.0002) were found in the JavaFit Diet Plus™ coffee group while no significant changes were noted in the regular coffee group. No changes in comprehensive clinical chemistry panels of serum and plasma were noted between groups. These data suggest that consuming JavaFit™ coffee prior to training may improve body composition with no adverse effects.

### Experimental Approach

Subjects were recruited from a small suburban community in northeastern Ohio by word of mouth and posted announcements. Forty six apparently healthy and recreationally active subjects, men (n=16) and women (n=30), agreed to participate in the study (see Table 1). Prior to obtaining written informed consent from each subject, an institutional review board (IntegReview, Inc, Austin, Tex.) approved the experimental protocol. All subjects had previously regularly drank caffeinated coffee on a daily basis. Subjects were excluded from the study if they were smokers, had any known metabolic disorder, or were currently taking any medications or nutritional supplements that contained caffeine and/or ephedra. All procedures in the study were in accord with ethical standards set forth in the Helsinki Declaration of 1975, as revised in 1983.

TABLE 1
Subject Characteristics (mean ± SD)

| | Age (yrs) | Weight (kg) | % Fat |
|---|---|---|---|
| Female (n = 30) | 37.5 ± 7.8 | 72.9 ± 9.5 | 42.4% ± 6.5 |
| Male (n = 16) | 38.5 ± 5.1 | 95.3 ± 15.5 | 31.4% ± 6.9 |
| JavaFit (n = 23) | 38.6 ± 7.5 | 76.8 ± 11.1 | 40.7% ± 8.1 |
| Placebo (n = 23) | 37.1 ± 6.4 | 84.6 ± 19.1 | 36.4% ± 8.4 |

### Diet and Physical Activity

This study employed a free-living design whereby subjects were advised to maintain their normal diet during the study. To verify this, subjects completed 3-d food records (which included two weekdays and one weekend day) during baseline testing, week 4, and week 8. All food records were analyzed by a licensed, registered dietitian using commercially available software (NutriBase IV Clinical Edition, AZ). To enhance accuracy of the food records, all subjects received instruction during baseline testing on how to accurately estimate portion sizes. This counselling was reinforced during each visit to the laboratory. No dietary supplements were allowed with the exception of standard strength multivitamins.

Subjects were instructed on performing a standardized workout consisting of whole-body resistance training followed by a cardiovascular workout. Aerobic workouts were performed a minimum of 3 sessions per week for a minimum of 15 minutes. Subjects were permitted to perform their aerobic workout longer if they so desired.

### Body Composition

Body weight was measured using a calibrated digital A&D™ Medical Scale (Model UC-300, Milpitas, Calif.) and standing height was measured using a wall-mounted stadiometer (Seca Model 216, Hanover, Md.). Body composition was measured with dual-energy x-ray absorptiometry (GE Lunar DPX Pro, Madison, Wis.) with all DEXA scans performed by the same technician and analyzed according to software (enCORE version 7.53.002, 2003) provided by the manufacturer. In short, subjects were positioned on the scanner following standard procedures and remained motionless during the whole body scan (approximately 15 minutes). Using a three-compartment model, DEXA calculates fat mass, lean mass, and bone mass. Percent fat was calculated by dividing fat mass by the total scanned mass. Quality control calibration procedures were performed prior to all scans using a calibration block provided by the manufacturer.

### Statistical Analyses

Statistical analyses were conducted using Statistica version 7.1 (Stat Soft Inc., Tulsa, Okla.). Two-way 2 (Beverage)×2 (Time) ANOVA with repeated measures on both factors were used to analyze between group differences in body composition. If a significant interaction was observed, Tukey HSD post-hoc testing was used to determine pairwise differences between means. Differences were considered statistically significant when the probability of type I error was less than or equal to 0.05 (P≦0.05). Data are expressed as the means+standard deviation.

### RESULTS

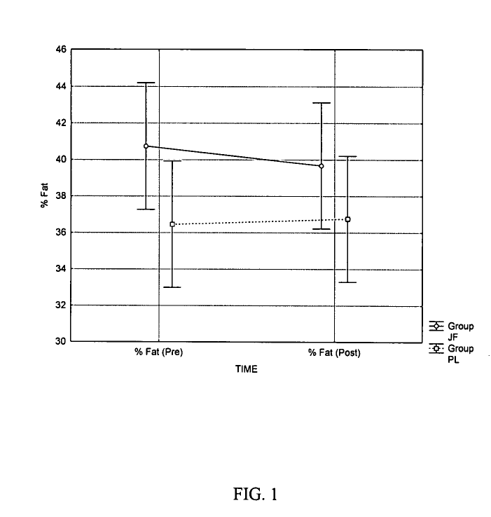

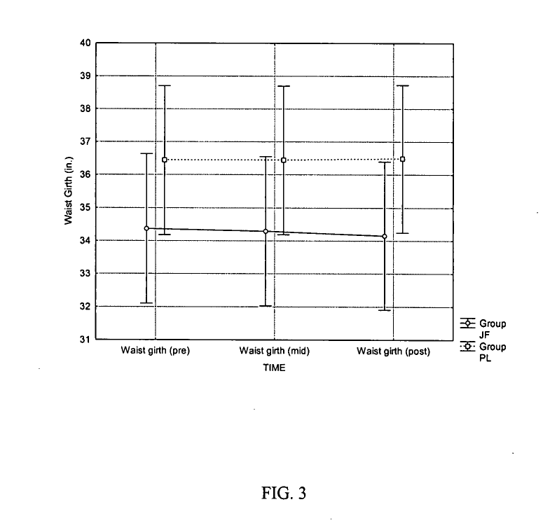

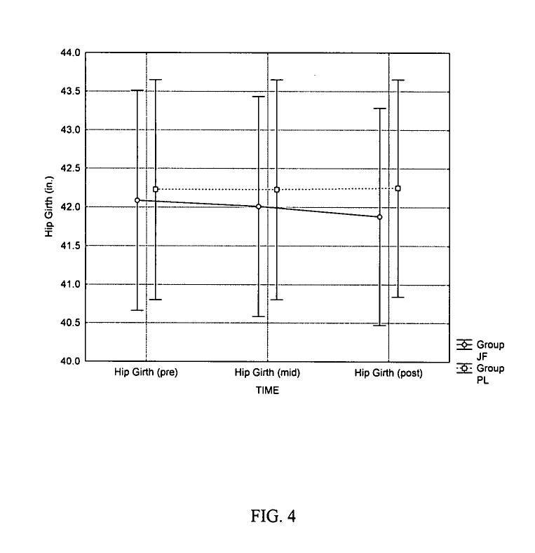

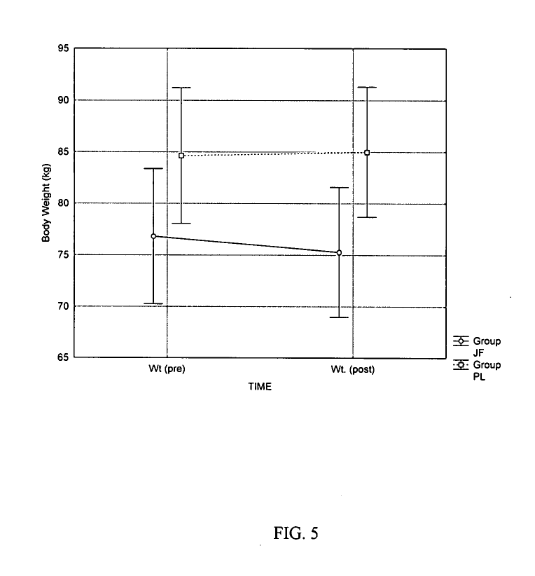

Body composition data are expressed as change from pre (week 0) values. Two-way ANOVA revealed a significant group x time decrease in % fat (JavaFit™ coffee group: −1.1±1.1%; vs. regular coffee: +0.3±1.2%; p<0.001) and fat mass (JavaFit™ coffee group: −1.3±1.4 kg; vs. regular coffee: +0.4±1.2 kg; p<0.001) over the course of the study (FIGS. 1 & 2, respectively). Also, significant decreases in waist girth (−0.56±0.34 cm; p<0.006), hip girth (−0.53±0.27 cm; p<0.001) and body weight (−1.54±1.7 kg; p<0.0002) were found in the JavaFit™ coffee group (“JF”) while no significant changes were noted in the regular coffee group (FIGS. 3, 4, 5, respectively). No changes in comprehensive clinical chemistry panels of serum and plasma were noted between groups. No adverse events were reported during the study.

Another study was conducted which shows beneficial effects of a composition according to one embodiment of the invention by Hoffman et al. was published in the Journal of the International Society of Sports Nutrition 3(1): pp. 35-41, 2006 and the contents of that publication are herein fully incorporated by reference thereto.

Another study was conducted which shows beneficial effects of a composition according to one embodiment of the invention by Hoffman et al. and was published in the Journal of Strength and Conditioning Research, 2007, 21(2), pp 456-459 and the contents of that publication are herein fully incorporated by reference thereto.

Another study was conducted which shows beneficial effects of a composition according to one embodiment of the invention by Taylor et al. to be published in the Journal of the International Society of Sports Nutrition 2007, 4:10, the contents of which are herein fully incorporated by reference thereto. The publication is presently available at http://www.jissn.com/content/4/1/10 and is assigned ISSN number 1550-2783

Consideration must be given to the fact that although this invention has been described and disclosed in relation to certain preferred embodiments, obvious equivalent modifications and alterations thereof will become apparent to one of ordinary skill in this art after reading and understanding this specification and the claims appended hereto. The present invention includes the subject matter defined by any combination of any one of the various claims appended hereto with any one or more of the remaining claims, including the incorporation of the features of any dependent claim, singly or in combination with other dependent claims into any independent claim, either alone or in combination with the features or limitations of any other independent claim, with the remaining dependent claims in their original text being read and applied to any independent claim so modified. The present invention includes coffees brewed using any dry composition specified in either this specification or the claims appended hereto, including latte's and expresso varieties. Further, it is to be understood that the use of the word “about” as a modifier for a numerical value includes the actual numerical value itself. Unless specified to the contrary, all parts and percentages set forth herein are on a parts by weight basis.

We claim:

1) A dry composition of matter which comprises:
a) a coffee selected from the group consisting of: coffee beans and ground coffee beans;
b) added caffeine;
c) one or more materials selected from the group consisting of: citrus aurantium; garcinia cambogia; chromium; potassium; cayenne pepper; a source of calcium ions; green tea extract; and niacin.

2) A composition according to claim 1 comprising at least two materials selected from the group consisting of: citrus aurantium; garcinia cambogia; chromium; cayenne pepper; a source of calcium ions; green tea extract; an niacin.

3) A composition according to claim 1 wherein said one or more materials comprises calcium, present an any amount between about 0.80 and 10% by weight based on the total weight of said composition.

4) A composition according to claim 1 wherein said one or more materials comprises garcinia cambogia, present an any amount between about 2% and about 6% by weight based on the total weight of said composition.

5) A composition according to claim 1 wherein said one or more materials comprises chromium, present an any amount between about 0.001% and 0.002% by weight based on the total weight of said composition.

6) A composition according to claim 1 wherein said one or more materials comprises citrus aurantium, present an any amount between about 0.0001% and 0.0002% by weight based on the total weight of said composition.

7) A composition according to claim 1 wherein said one or more materials comprises niacin, present an any amount between about 0.02% and 0.05% by weight based on the total weight of said composition.

8) A composition according to claim 1 wherein said one or more materials comprises green tea extract, present an any amount sufficient to provide between about 1.5% and about 3% by weight based on the total weight of said composition of epigallocatechin gallate.

9) A brewed coffee which comprises deer velvet antler, present in an amount between about 0.05% and 1% by weight based on the total weight of the coffee; and glutamine, present in any amount between about 0.005% and 0.25% by weight based on the total weight of said composition.
